(19) United States
(12) Patent Application Publication
(10) Pub. No.: US 2016/0030918 A1
(43) Pub. Date: Feb. 4, 2016

(54) MOISTURE-ABSORBING MATERIAL, METHOD FOR MANUFACTURING SAME, AND PACKAGING MATERIAL

(71) Applicant: FUJIFILM CORPORATION, Tokyo (JP)

(72) Inventors: Hideki KAIMOTO, Shizuoka (JP); Naoko NAKAZAWA, Shizuoka (JP); Takao ASAKURA, Shizuoka (JP); Wataru ONO, Shizuoka (JP)

(21) Appl. No.: 14/882,471

(22) Filed: Oct. 14, 2015

Related U.S. Application Data
(63) Continuation of application No. PCT/JP2014/062525, filed on May 9, 2014.

(30) Foreign Application Priority Data
May 10, 2013 (JP) 2013-100575
Apr. 14, 2014 (JP) 2014-083198

(51) Int. Cl. B01J 20/26; B32B 27/36; B01J 20/10; B32B 37/14; B01J 20/32; B32B 7/12; B32B 27/32

(52) U.S. Cl. CPC B01J 20/26; B32B 7/12; B32B 27/36; B32B 27/32; B32B 37/14; B01J 20/3287; B01J 20/3236; B01J 20/103; B32B 2264/102; B32B 2307/7246; B32B 2255/10; B32B 2307/726; B32B 2439/70; B32B 2255/20; B32B 2255/26

(57) ABSTRACT

Provided is a moisture-absorbing material having, in the following order: a moisture-permeable polymer layer; a moisture-absorbing layer having a porous structure and containing amorphous silica with an average secondary particle diameter not exceeding 10 μm, a water-soluble resin and a moisture-absorbing agent; and a moisture-proof layer.

### CROSS-REFERENCE TO RELATED APPLICATIONS

This application is a continuation application of International Application No. PCT/JP2014/062525, filed May 9, 2014, the disclosure of which is incorporated herein by reference in its entirety. Further, this application claims priority from Japanese Patent Application No. 2013-100575, filed May 10, 2013, and Japanese Patent Application No. 2014-083198, filed Apr. 14, 2014, the disclosures of which are incorporated herein by reference in their entirety.

### BACKGROUND OF THE INVENTION

1. Field of the Invention

The present invention relates to a moisture-absorbing material, a method for manufacturing the same, and a packaging material.

2. Description of the Related Art

In general, dried products of foods, medicines and the like are enclosed with a pouch with a drying agent such as silica gel or the like in a packaging to protect the contents from moisture in the atmosphere by keeping humidity low in the packaging. The order of this packaging is as follows. A dried product is put into a bag-like packaging material, a pouch with a drying agent is further put into the packaging material, and then the bag-like packaging material is sealed. The step of putting the pouch with a drying agent into the packaging material is generally automated. However, the step of putting the pouch with a drying agent into the packaging material itself makes the packaging process complicated and the pouch with a drying agent may be put into the packaging material by hand depending on the dried product, which is troublesome. Further, in the case in which the dried product is a food such as a confectionery, a drying agent is enclosed with the food and thus there is a possibility that the drying agent may be accidentally mixed with the food or accidentally swallowed.

Instead of the pouch with a drying agent, a film with a drying agent that can be used as a packing material has been proposed.

For example, in JP3919503B, there is disclosed a drying agent mixed film formed by kneading a powdered drying agent such as a molecular sieve into a resin. The moisture-absorbing performance of the drying agent mixed film is determined by the moisture absorption capacity of a drying agent to be kneaded and the moisture-absorbing rate of the drying agent. The content of the drying agent in the film is limited due to exhibition of physical properties as a film, and in the application which requires storage for a long period of time, there arises a problem of insufficient moisture absorption capacity. In addition, when the moisture-absorbing rate of the drying agent is excessively high, the drying agent is quickly saturated and there arises a problem of loss of the function as a drying agent.

In JP2009-240935A, as a packaging material with increased moisture absorption capacity, there is disclosed a sheet for dehumidification in which a moisture-absorbing agent is supported on porous silica to be contained in a fiber sheet. In JP2012-110818A, there is disclosed a moisture-absorbing and releasing sheet which contains a moisture-absorbing agent made of porous silica and a binder of a water-soluble organic polymer compound. In WO2005/75068A, there is disclosed a packaging material using an adsorbing performance imparting agent which contains porous silica having a predetermined average pore diameter, average particle diameter and specific surface area.

In JP2006-44777A, as a method for controlling a moisture-absorbing rate, a method using a plate-like formed body obtained by foaming a thermoplastic resin with a physical foaming agent such as nitrogen or the like is disclosed. In WO2005/053821A, there is disclosed a method for laminating various films of polyolefin or the like on a film containing zeolite.

### SUMMARY OF THE INVENTION

However, the fact is that a material having both a large moisture absorption capacity and high transparency is not proposed and a material having a large moisture absorption capacity and high transparency and capable of controlling a moisture-absorbing rate is also not proposed.

An object of the present invention is to provide a moisture-absorbing material having a large moisture absorption capacity and high transparency and capable of controlling a moisture-absorbing rate by a constituent material, a method for manufacturing the same, and a packaging material.

Specific means for solving the above-described problems are described below.

<1> A moisture-absorbing material including, in the following order: a moisture-permeable polymer layer; a moisture-absorbing layer having a porous structure and including amorphous silica having an average secondary particle diameter of 10 μm or less, a water-soluble resin and a moisture-absorbing agent; and a moisture-proof layer.

<2> The moisture-absorbing material according to <1>, in which the moisture-absorbing layer has a thickness of 20 μm to 50 μm, and the moisture-absorbing layer has a void volume of 45% to 85%.

<3> The moisture-absorbing material according to <1> or <2>, in which the amorphous silica includes at least one of vapor phase process silica and wet silica.

<4> The moisture-absorbing material according to any one of <1> to <3>, in which the moisture-absorbing layer has an average pore diameter of 40 nm or less.

<5> The moisture-absorbing material according to <3> or <4>, in which the vapor phase process silica has an average primary particle diameter of 10 nm or less.

<6> The moisture-absorbing material according to <5>, in which the vapor phase process silica has an average secondary particle diameter of 25 nm or less.

<7> The moisture-absorbing material according to any one of <1> to <6>, in which the water-soluble resin includes a polyvinyl alcohol having a saponification degree of 99% or less and a polymerization degree of 3,300 or higher.

<8> The moisture-absorbing material according to any one of <1> to <7>, in which the moisture-absorbing layer further includes boric acid as a crosslinking agent.

<9> The moisture-absorbing material according to any one of <1> to <8>, in which the moisture-absorbing agent includes calcium chloride.

<10> The moisture-absorbing material according to any one of <1> to <9>, in which the polymer layer has a thickness of 20 μm to 100 μm.

<11> The moisture-absorbing material according to any one of <1> to <10>, further including: an adhesive layer between the moisture-proof layer and the moisture-absorbing layer.

<12> The moisture-absorbing material according to <11>, in which the adhesive layer includes a polyurethane resin adhesive, and the adhesive layer has a thickness of 3 μm to 15 μm.

<13> A packaging material including: the moisture-absorbing material according to any one of <1> to <12>.

<14> A packaging material including: one or a plurality of the moisture-absorbing material according to any one of <1> to <12>, in which the packaging material has an adhesion site in which a part of a polymer layer of one moisture-absorbing material is bonded with another part of the moisture-absorbing material, or an adhesion site in which a part of a polymer layer of a first moisture-absorbing material is bonded with a part of a second moisture-absorbing material.

<15> A method for manufacturing a moisture-absorbing material, including:

forming a moisture-absorbing layer by forming a layer having a porous structure by applying a coating liquid including amorphous silica having an average secondary particle diameter of 10 μm or less and a water-soluble resin to any one of a moisture-permeable polymer layer and a moisture-proof layer and applying a solution including a moisture-absorbing agent to the porous structure to impregnate the porous structure with the moisture-absorbing agent; and

laminating the other one of the polymer layer and the moisture-proof layer on the moisture-absorbing layer impregnated with the moisture-absorbing agent.

<16> The method for manufacturing a moisture-absorbing material according to <15>, in which the moisture-absorbing agent includes calcium chloride.

According to the present invention, there are provided a moisture-absorbing material having a large moisture absorption capacity and high transparency and capable of controlling a moisture-absorbing rate by a constituent material, a method for manufacturing the same, and a packaging material.

### BRIEF DESCRIPTION OF THE DRAWINGS

FIG. 1 is a schematic sectional view showing an example of a lamination structure of a moisture-absorbing material of the present invention.

FIG. 2 is a schematic sectional view showing an example of a packaging material that is formed into a bag by folding a moisture-absorbing material and bonding 3 sides excluding the folded portion.

FIG. 3 is a perspective view showing an example of a packaging material that is formed into a bag by bonding each of 4 sides corresponding to a first moisture-absorbing material and a second moisture-absorbing material.

FIG. 4 is a schematic sectional view showing an example of a packaging material of the present invention.

FIG. 5 is an enlarged view showing a sectional view of an adhesion site of a bag-like packaging material.

FIG. 6 is a schematic sectional view showing another example of the packaging material of the present invention.

### DESCRIPTION OF THE PREFERRED EMBODIMENTS

Hereinafter, a moisture-absorbing material of the present invention, a method for manufacturing the same and a packaging material using the same will be described in detail.

In a case in which the amount of each component in a composition is indicated in the present specification, when plural substances corresponding to each component are present in the composition, the indicated amount means the total amount of the plural substances present in the composition unless specifically stated otherwise.

A solid content in the present specification also includes a liquid component such as a low molecular weight component except for a solvent.

In the present specification, a numerical range indicated using “to” indicates a range including a numerical value given before “to” as a minimum value and a numerical value given after “to” as a maximum value.

<Moisture-Absorbing Material>

The moisture-absorbing material according to the present invention includes a moisture-permeable polymer layer, a moisture-absorbing layer having a porous structure and containing amorphous silica having an average secondary particle diameter of 10 μm or less, a water-soluble resin and a moisture-absorbing agent, and a moisture-proof layer.

The moisture-absorbing material in the present invention may include another layer such as an adhesive layer as required.

Although the function of the moisture-absorbing material of the present invention is not clear, it is assumed as follows.

In the moisture-absorbing material in the present invention, the moisture-absorbing layer including amorphous silica having a small diameter, a water-soluble resin and a moisture-absorbing agent has a three-dimensional structure having a high void volume. Due to the fact that the moisture-absorbing agent is adsorbed onto the surface of the amorphous silica in which a three-dimensional structure is formed, the moisture absorption capacity of the moisture-absorbing agent can be retained and moisture in the voids of the moisture-absorbing layer having a wide surface area can be also retained. Accordingly, a wide hygroscopic surface can be secured in the moisture-absorbing material and thus it is considered that a high moisture-absorbing rate and a larger moisture absorption capacity than that of than a moisture-absorbing material of the related art can be obtained. In addition, when the secondary particle diameter of the amorphous silica is controlled to be small and the amorphous silica is dispersed in the moisture-absorbing layer, the transparency of the moisture-absorbing material can be maintained at a high level. Therefore, it is considered that both a large moisture absorption capacity and transparency can be achieved in the moisture-absorbing material. This is more effective particularly in the case in which the porous structure of the moisture-absorbing layer is formed with vapor phase process silica.

—Moisture-Absorbing Layer—

The moisture-absorbing layer in the present invention has a porous structure and contains amorphous silica having an average secondary particle diameter of 10 μm or less, a water-soluble resin and a moisture-absorbing agent, and the moisture-absorbing layer may further contain a crosslinking agent. In addition, the moisture-absorbing layer may contain other components such as a dispersing agent and a surfactant as required.

The moisture-absorbing rate of the moisture-absorbing layer can be controlled by changing the thickness of the layer and the kind of the moisture-absorbing agent. Further, the moisture-absorbing rate of the moisture-absorbing material in the moisture-absorbing layer can be controlled by changing the thickness of an adhesive layer used for bonding the layers during lamination and the kind of the adhesive.

(Amorphous Silica)

The moisture-absorbing layer in the present invention contains at least one kind of amorphous silica having an average secondary particle diameter of 10 μm or less.

The amorphous silica is in the form of porous unstructured particles in which a three-dimensional structure of SiO₂ is formed and is roughly classified into wet process silica and dry process (vapor phase process) silica according to the production processes. Examples of the amorphous silica include synthetic amorphous silica such as vapor phase process silica obtained by a dry process and wet silica obtained by a wet process.

—Vapor Phase Process Silica—

The vapor phase process silica is silica (silica particles) obtained by evaporating silicon chloride to synthesize the silica particles by a vapor phase reaction in a high temperature hydrogen flame.

Since the vapor phase process silica has a low refractive index, transparency can be imparted to the moisture-absorbing layer by dispersing the silica particles until an appropriate fine particle diameter is obtained. As described above, it is important that the moisture-absorbing layer is transparent from the viewpoint that the contents of a packaging can be visually checked and an indicator function or the like can be provided.

In addition, the vapor phase process silica is different from hydrated silica in density of a silanol group on the surface and the presence/absence of voids, and exhibits properties different from those of hydrated silica. However, the vapor phase process silica is suitable for forming a three-dimensional structure having a high void volume. Although the reason is not clear, it is assumed that in the case of hydrated silica, the density of the silanol group on the surface of the fine particles is as large as 5 groups/nm² to 8 groups/nm² and the silica fine particles easily aggregate. On the other hand, it is assumed that in the case of vapor phase process silica, the density of the silanol group on the surface of the fine particles is as small as 2 groups/nm² to 3 groups/nm² and thus the fine particles form coarse and soft aggregates (flocculate), thereby forming a porous structure having a high void volume.

As the vapor phase process silica included in the moisture-absorbing layer, vapor phase process silica in which the density of the silanol group on the surface is 2 groups/nm² to 3 groups/nm² is preferable. The average primary particle diameter of the vapor phase process silica included in the moisture-absorbing layer is not particularly limited and is preferably 20 nm or less and more preferably 10 nm or less from the viewpoint of transparency of the moisture-absorbing layer.

The average secondary particle diameter of the vapor phase process silica included in the moisture-absorbing layer is 10 μm or less, preferably 50 nm or less, and more preferably 25 nm or less from the viewpoint of the transparency of the moisture-absorbing layer. In addition, it is preferable that the secondary particle diameter distribution is even from the viewpoint of transparency of the moisture-absorbing layer, and the standard deviation is preferably 10 nm or less, more preferably 8 nm or less, and particularly preferably 5 nm or less.

When the average secondary particle diameter of the vapor phase process silica is greater than 10 μm, transparency and visibility cannot be secured.

The average primary particle diameter in the present invention refers to an average particle diameter of primary particles obtained by observing 100 fine particles with a transmission type electron microscope to obtain each projection area, obtaining a diameter when a circle having an area equal to the projection area is presumed, and simply averaging the diameters of the 100 fine particles.

In addition, the average secondary particle diameter in the present invention refers to average particle diameter of secondary particles obtained by observing 100 aggregated particles with a scanning type electron microscope to obtain each projection area, obtaining a diameter when a circle having an area equal to the projection area is presumed, and simply averaging the diameters of the 100 aggregated particles.

Examples of the vapor phase process silica include AEROSIL (manufactured by Nippon Aerosil Co., Ltd.), REOLOSIL (manufactured by Tokuyama Corporation), WAKER HDK (manufactured by Wacker Asahikasei Silicone Co., Ltd.) and CAB-O-SIL (manufactured by Cabot Corporation). AEROSIL 300SF75 (manufactured by Nippon Aerosil Co., Ltd.) is preferable.

—Wet Silica—

The wet silica is hydrated silica obtained by decomposing silicate with an acid to form active silica, polymerizing the active silica to an adequate degree and allowing the resultant polymerized product to aggregate and precipitate.

The wet silica is classified into precipitation process silica, gel process silica, and sol process silica according to the production processes. In the case of the precipitation process silica, silica particles which have been produced by reacting sodium silicate with sulfuric acid under alkaline conditions and having undergone particle growth, are subjected to aggregation and precipitation, and then are subjected to steps of filtration, water washing, drying, pulverization and classification, to be provided as final products. Examples of the precipitation process silica include NIPSIL manufactured by Tosoh Silica Corporation, and TOKUSIL manufactured by Tokuyama Corporation. The gel process silica is produced by reacting sodium silicate with sulfuric acid under acidic conditions. Specific examples of the gel process silica include NIPGEL manufactured by Tosoh Silica Corporation, and SYLOID and SYLOJET manufactured by Grace Japan Co., Ltd.

The specific surface area of the amorphous silica included in the moisture-absorbing layer by a BET method is preferable 200 m²/g or more and more preferably 250 m²/g or more. When the specific surface area of the vapor phase process silica is 200 m²/g or more, the transparency of the moisture-absorbing layer can be maintained at a high level.

The BET method used in the present invention is a method for measuring the surface area of powder by a vapor phase adsorption process, and more specifically, is a method for obtaining the total surface area per g of a sample, that is, the specific surface area, from the adsorption isotherm. Nitrogen gas is commonly used as the adsorption gas, and a method for measuring the amount of adsorption by the change in pressure or volume of the adsorbed gas is most widely used as a measurement method. The most famous equation describing the adsorption isotherm of a multi-molecular system is the equation of Brunauer, Emmett, and Teller, called the BET equation, and is widely used for determining the surface area. The surface area is calculated by multiplying the adsorption amount obtained by the BET equation by the surface area occupied by a single adsorbed molecule.

The content of the amorphous silica in the moisture-absorbing layer is preferably 20% by mass to 80% by mass and more preferably 30% by mass to 70% by mass with respect to the total solid content of the moisture-absorbing layer from the viewpoint of moisture absorption capacity and transparency of the moisture-absorbing layer.

In the moisture-absorbing layer of the present invention, as dispersing means for realizing the secondary particle diameter of a vapor phase process silica, the addition of a dispersing agent is preferable and for example, a cationic polymer can be used. Examples of the cationic polymer include a mordant described in paragraphs “0138” to “0148” of JP2006-321176A.

In addition, as dispersing means for realizing the secondary particle diameter of the above-described vapor phase process silica, for example, various kinds of conventionally known dispersing machines such as a high speed rotating dispersing machine, a medium stirring type dispersing machine (ball mill, sand mill, beads mill, and the like), an ultrasonic dispersing machine, a colloid mill dispersing machine, or a high pressure dispersing machine can be used. Among these, as a dispersing machine, a beads mill dispersing machine and a liquid-liquid impact type dispersing machine are preferable, and a liquid-liquid impact type dispersing machine is more preferable. Examples of the liquid-liquid impact type dispersing machine include ULTIMAIZER, manufactured by Sugino Machine Limited.

(Water-Soluble Resin)

The moisture-absorbing layer contains at least one water-soluble resin.

Since the moisture-absorbing layer contains a water-soluble resin, the moisture-absorbing layer contains the vapor phase process silica in a state in which the vapor phase process silica is more suitably dispersed and thus the layer strength is further improved.

The water-soluble resin in the present invention refers to a resin that finally dissolves in an amount of 0.05 g or more in 100 g of 20° C. water through a heating or cooling step and preferably refers to a resin that dissolves in an amount of 0.1 g or more.

Examples of the water-soluble resin in the present invention include polyvinyl alcohol resins that are resins having hydroxy groups as hydrophilic structure units (such as polyvinyl alcohol (PVA), acetoacetyl modified polyvinyl alcohol, cationic modified polyvinyl alcohol, anionic modified polyvinyl alcohol, silanol modified polyvinyl alcohol, and polyvinylacetal), cellulose resins (such as methylcellulose (MC), ethylcellulose (EC), hydroxyethylcellulose (HEC), carboxymethyl cellulose (CMC), hydroxypropylcellulose (HPC), hydroxyethylmethyl cellulose, and hydroxypropylmethylcellulose), chitins, chitosans, starch, resins having ether bonds (such as polypropyleneoxide (PPO), polyethyleneglycol (PEG), and polyvinylether (PVE)), and resins having carbamoyl groups (such as polyacrylamide (PAAM), polyvinyl pyrrolidone (PVP), and polyacrylic acid hydrazide). In addition, polyacrylic acid salts having carboxyl groups as dissociable groups, maleic acid resins, alginic acid salts, and gelatins can also be exemplified.

Among these water-soluble resins, from the viewpoint of film strength of the moisture-absorbing layer, polyvinyl alcohol resins are preferably and polyvinyl alcohol is particularly preferable.

The polymerization degree of the water-soluble resin is preferably 1,500 or more, more preferably 2,000 or more, and still more preferably 3,300 or more. In addition, the polymerization degree of the water-soluble resin is 4,500 or less.

Among these, from the viewpoint of film strength of the moisture-absorbing layer, it is preferable that the water-soluble resin is a polyvinyl alcohol resin and the polymerization degree of the polyvinyl alcohol resin is 1,800 or more. The polymerization degree of the polyvinyl alcohol resin is more preferably 2,000 or more. The polymerization degree of the polyvinyl alcohol resin is further preferably 2,400 or more. The polymerization degree of the polyvinyl alcohol resin is still more preferably 4,500 or less.

In addition, the saponification degree of the water-soluble resin is preferably 99% or less, more preferably 95% or less, and still more preferably 90% or less. Further, the saponification degree of the water-soluble resin is preferably 70% or more, more preferably 78% or more, and still more preferably 85% or more.

Among these, from the viewpoint of transparency of the moisture-absorbing layer, it is preferable that the water-soluble resin is a polyvinyl alcohol resin and the saponification degree of the polyvinyl alcohol resin is 70% or more and 99% or less. The saponification degree of the polyvinyl alcohol resin is more preferably 78% or more and 99% or less. The saponification degree of the polyvinyl alcohol resin is still more preferably 85% or more and 99% or less.

When the saponification degree of the water-soluble resin is 70% or more, the resin is suitable for retaining water solubility in practical use.

Furthermore, the water-soluble resin is preferably polyvinyl alcohol. In this case, the saponification degree and the polymerization degree are preferably within the following ranges.

That is, when boric acid is used as a crosslinking agent used at the time of crosslinking of the polyvinyl alcohol, the saponification degree of the polyvinyl alcohol is preferably within a range of 78% to 99%, and the polymerization degree thereof is preferably within a range of 1,500 to 4,500 and more preferably within a range of 2,400 to 3,500.

On the other hand, when a crosslinking agent is not used, it is preferable that the saponification degree of the polyvinyl alcohol is low and the polymerization degree is high from the viewpoint of forming the same porous structure as in the case in which a crosslinking agent is used. Specifically, the saponification degree of the polyvinyl alcohol is preferably within a range of 78% to 99% and the polymerization degree of the polyvinyl alcohol is preferably within a range of 2,400 to 4,500.

The water-soluble resin also includes derivatives of the above-described specific examples. The water-soluble resin contained in the moisture-absorbing layer may be used alone or in combination of two or more kinds thereof.

The content of the water-soluble resin in the moisture-absorbing layer (the total amount when two or more kinds of water-soluble resins are used in combination) is preferably 4.0% by mass to 16.0% by mass and more preferably 6.0% by mass to 14.0% by mass with respect to the total solid content of the moisture-absorbing layer from the viewpoints of preventing a decrease in film strength or cracking while drying, which are caused by an excessively low content of the water-soluble resin, and preventing a reduction in hygroscopicity that results from a decrease in void volume due to an increased tendency for voids to become clogged by the resin, which is caused by an excessively high content of the water-soluble resin.

In addition, when the water-soluble resin is polyvinyl alcohol and boric acid is used as a crosslinking agent used at the time of crosslinking of the polyvinyl alcohol, the content of the polyvinyl alcohol in the moisture-absorbing layer is preferably 10% by mass to 60% by mass and more preferably 15% by mass to 30% by mass with respect to the amount of amorphous silica. When the water-soluble resin is polyvinyl alcohol and a crosslinking agent for polyvinyl alcohol is not used, the content of the polyvinyl alcohol in the moisture-absorbing layer is preferably within a range of 25% by mass to 60% by mass with respect to the amount of amorphous silica.

The water-soluble resin has a hydroxyl group as the structure unit and the hydroxyl group and the silanol group on the surface of the vapor phase process silica form a hydrogen bond, which allows for easy formation of a three-dimensional network structure including secondary particles of the vapor phase process silica as chain units. It is considered that a moisture-absorbing layer having a porous structure with a great void volume can be formed due to formation of the three-dimensional network structure. It is assumed that the obtained moisture-absorbing layer having a porous structure functions as a layer for retaining moisture after moisture absorption.

(Crosslinking Agent)

The moisture-absorbing layer in the present invention can contain at least one crosslinking agent. An embodiment in which the moisture-absorbing layer has a porous structure cured by a crosslinking reaction of the crosslinking agent with the water-soluble resin (for example, polyvinyl alcohol) is preferable.

As the crosslinking agent, a suitable crosslinking agent may be appropriately selected in relation to the water-soluble resin included in the moisture-absorbing layer. Among crosslinking agents, a boron compound is preferable from the viewpoint of rapid crosslinking reaction, and examples of the boron compound include borax, boric acid, borates (for example, orthoborates, InBO₃, ScBO₃, YBO₃, LaBO₃, Mg₃(BO₃)₂, and Co₃(BO₃)₂), diborates (for example, Mg₂B₂O₅ and Co₂B₂O₅), metaborates (for example, LiBO₂, Ca(BO₂)₂, NaBO₂, and KBO₂), tetraborates (for example, Na₂B₄O₇.10H₂O), and pentaborates (for example, KB₅O₈.4H₂O, Ca₂B₆O₁₁.7H₂O, and CsB₅O₅).

Among these boron compounds, from the viewpoint of rapider crosslinking reaction, borax, boric acid and borates are preferable and boric acid is particularly preferable. The boron compound is most preferably used in combination with a polyvinyl alcohol resin which is suitably used for the water-soluble resin.

On the other hand, from the viewpoint of environmental suitability, the crosslinking agent may not include boric acid.

The content of the boron compound of the moisture-absorbing layer is preferably within a range of 0.15% by mass to 5.80% by mass and more preferably within a range of 0.75% by mass to 3.50% by mass with respect to 4.0% by mass to 16.0% by mass of polyvinyl alcohol. When the content of the boron compound is within the above range, the polyvinyl alcohol is effectively crosslinked and thus cracking or the like can be prevented.

When gelatin is used as the water-soluble resin, the following compounds other than the boron compound can be also used as the crosslinking agent (hereinafter, also referred to as “other crosslinking agents”).

Examples of other crosslinking agents include aldehyde compounds such as formaldehyde, glyoxal and glutaraldehyde; ketone compounds such as diacetyl and cyclopentanedione; active halogen compounds such as bis(2-chloroethylurea)-2-hydroxy-4,6-dichloro-1,3,5-triazine and 2,4-dichloro-6-S-triazine sodium salt; active vinyl compounds such as divinyl sulfonic acid, 1,3-vinylsulfonyl-2-propanol, N,N′-ethylene bis(vinyl sulfonyl acetamide) and 1,3,5-triacryloyl-hexahydro-S-triazine; N-methylol compounds such as dimethylol urea and methylol dimethylhydantoin; melamine resins (for example, methylol melamine and alkylated methylol melamine); epoxy resin; isocyanate compounds such as 1,6-hexamethylenediisocyanate; aziridine compounds described in U.S. Pat. No. 3,017,280A and U.S. Pat. No. 2,983,611A; carboximide compounds described in U.S. Pat. No. 3,100,704A; epoxy compounds such as glycerol triglycidyl ether; ethyleneimino compounds such as 1,6-hexamethylene-N,N′-bisethyleneurea; halogenated carboxyaldehyde compounds such as mucochloro acid and mucophenoxy chloro acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compounds such as adipic acid dihydrazide; and low molecules or polymers containing two or more oxazoline groups. The other crosslinking agents may be used alone or in combination of two or more kinds thereof.

(Moisture-Absorbing Agent)

The moisture-absorbing layer in the present invention contains at least one moisture-absorbing agent.

Examples of the moisture-absorbing agent include silica gel, zeolite, water-absorbing polymers, and hygroscopic salts and from the viewpoint of moisture-absorbing rate, hygroscopic salts are preferable.

Specific examples of the hygroscopic salts include halogenated metal salts such as lithium chloride, calcium chloride, magnesium chloride, and aluminum chloride, metal sulfates such as sodium sulfate, potassium sulfate, magnesium sulfate, and zinc sulfate, metal acetates such as potassium acetate, amine salts such as dimethylamine hydrochloride, phosphate compounds such as orthophosphoric acid, guanidine salts such as guanidine hydrochloride, guanidine phosphate, guanidine sulfamate, guanidine methylolphosphate, guanidine carbonate, potassium hydroxide, sodium hydroxide, and magnesium hydroxide. Among these, from the viewpoint of moisture absorption capacity, calcium chloride is preferable.

The coating amount of the moisture-absorbing agent on the moisture-absorbing layer is preferably 1 g/m² to 20 g/m², more preferably 2.5 g/m² to 15 g/m², and particularly preferably 5 g/m² to 13 g/m² from the viewpoint of achieving both moisture absorption capacity and transparency.

The thickness of the moisture-absorbing layer in the present invention is preferably 20 μm to 50 μm, more preferably 25 μm to 45 μm, and particularly preferably 30 μm to 45 μm from the viewpoint of achieving both moisture absorption capacity and transparency. When the thickness of the moisture-absorbing layer is within the above range, a larger moisture absorption capacity is obtained and satisfactory transparency can be also achieved.

The void volume of the moisture-absorbing layer in the present invention is preferably 45% to 85%, more preferably 50% to 80%, and particularly preferably 55% to 75%. When the void volume of the moisture-absorbing layer is 45% or more, a larger moisture absorption capacity is obtained and when the void volume of the moisture-absorbing layer is 85% or less, it is possible to prevent a decrease in film strength and to suppress cracking while drying.

As an example of a method for measuring the void volume, a method including measuring a void volume from a change in mass of a moisture-absorbing layer by a mercury intrusion method or by immersing the moisture-absorbing layer in an organic solvent such as diethylene glycol, and measuring the thickness of the moisture-absorbing layer by observing the section of the moisture-absorbing layer with a microscope to calculate a void volume can be used.

It is preferable that the thickness of the moisture-absorbing layer in the present invention is 20 μm to 50 μm and the void volume is 45% to 85%.

The average pore diameter of the moisture-absorbing layer in the present invention is preferably 40 nm or less, more preferably 30 nm or less, and particularly preferably 25 nm or less from the viewpoint of moisture absorption capacity. When the average pore diameter of the moisture-absorbing layer is 40 nm or less, sufficient transparency is obtained.

The average pore diameter is a value measured by the mercury intrusion method using Shimadzu AUTOPORE 9220 (manufactured by Shimadzu Corporation).

—Content Ratio Between Amorphous Silica and Water-Soluble Resin in Moisture-Absorbing Layer—

The content ratio between the amorphous silica (x) and the water-soluble resin (y) in the moisture-absorbing layer of the present invention [PB ratio (x/y), the mass of the amorphous silica with respect to 1 part by mass of the water-soluble resin] has a significant influence on the layer structure of the moisture-absorbing layer in some cases. That is, as the PB ratio increases, the void volume and pore volume increase.

Specifically, the PB ratio (x/y) of the moisture-absorbing layer is preferably 1.5/1 to 10/1 from the viewpoints of preventing a decrease in the layer strength and cracking while drying, which are caused by excessively high P/B ratios, and preventing a reduction in moisture absorption capacity that results from a decrease in void volume due to an increased tendency for voids to be clogged by the resin, which is caused by excessively low P/B ratios. In addition, the P/B ratio of the moisture-absorbing layer is more preferably 1.5/1 to 8/1 from the viewpoint of effectively enhancing the effect of suppressing a decrease in the film strength and cracking while drying.

When the moisture-absorbing material of the present invention is used as a packaging material, from the viewpoint of protecting the contents, the moisture-absorbing layer is required to have a sufficient film strength. Moreover, the sufficient film strength of the moisture-absorbing layer is also required from the viewpoint of preventing cracking, peeling, and the like of the moisture-absorbing layer when the moisture-absorbing material is cut into films. From the viewpoint of these cases, the PR ratio (x/y) of the moisture-absorbing layer is preferably 10/1 or less.

For example, when a coating liquid, prepared by completely dispersing vapor phase process silica having an average primary particle diameter of 10 nm or less and the polyvinyl alcohol with a high saponification degree at a PB ratio (x/y) of 1.5/1 to 10/1 in an aqueous solution, is applied onto a supporter and the resultant coating layer is dried, a three-dimensional network structure which has secondary particles of the silica particles as chain units is formed, whereby a film having an average pore diameter of 20 nm or less, a void volume of 45% to 85%, and a porous structure with high transparency can be easily formed.

—Polymer Layer—

The moisture-absorbing material in the present invention includes a moisture-permeable polymer layer (hereinafter, also referred to as a polymer layer).

The polymer layer in the present invention has moisture permeability suitable for the following water vapor permeability and the water vapor permeability of the moisture-permeable polymer layer is preferably 1 g/m²·day to 50 g/m²·day. The water vapor permeability is a value measured by a method prescribed in JIS Z 0208.

The polymer layer includes at least a polymer and may include other components as required.

Examples of the kind of the polymer include a linear low density polyethylene (LLDPE), a low density polyethylene (LDPE), a high density polyethylene (HDPE), a cast polypropylene (CPP), a biaxially oriented polypropylene (OPP), and a polyacrylonitrile (PAN). Particularly, from the viewpoint of versatility, LLDPE and CPP are preferable and CPP is more preferable.

The thickness of the polymer layer is preferably 20 μm to 100 μm and more preferably 25 μm to 80 μm.

When the thickness of the polymer layer is within the above range, both the handleability of the entire moisture-absorbing material and the handleability when the moisture-absorbing material is formed into a packaging material or the like can be achieved at a high level.

The moisture-absorbing rate of the polymer layer into the moisture-absorbing layer in the present invention can be controlled by changing the material and the thickness.

When the moisture-absorbing material of the present invention is used as a packaging material, the polymer layer can be used as an adhesion site.

—Moisture-Proof Layer—

The moisture-absorbing material in the present invention has a moisture-proof layer.

The moisture-proof layer in the present invention is not particularly limited as long as the layer includes a moisture-proof material. The moisture-proof layer is preferably a layer having a water vapor permeability of less than 1 g/m²·day. The water vapor permeability is a value measured by a method prescribed according to JIS Z 0208.

For the moisture-proof layer, one material may be used or a laminate of two or more materials may used. For example, for the moisture-proof layer, a material on which metal is deposited in advance may be used.

As the moisture-proof material, for the viewpoint of moisture-proof properties, a silica-deposited film or an alumina-deposited film is preferably used. In addition, an aluminum foil or an aluminum-deposited film which has high moisture-proof properties may be used. A commercially available moisture-proof material may be used and examples thereof include TECH BARRIER MX (silica-deposited PET) manufactured by Mitsubishi Plastics, Inc. and BARRIALOX (alumina-deposited PET) manufactured by Toray International, Inc.

The thickness of the moisture-proof layer is preferably 6 μm to 120 μm and more preferably 6 μm to 100 μm from the viewpoint of moisture-proof properties.

—Adhesive Layer—

The moisture-absorbing material in the present invention may have an adhesive layer.

The adhesive layer has moisture permeability and the moisture-absorbing rate of the moisture-absorbing layer can be controlled by changing the thickness and the kind of the adhesive layer.

The kind of the adhesive used for the adhesive layer is not particularly limited and examples thereof include urethane resin-based, polyester-based, acrylic resin-based, ethylene vinyl acetate resin-based, polyvinyl alcohol-based, polyamide-based, and silicone-based adhesives. From the viewpoint of adhesive strength, a polyurethane resin-based adhesive is preferable.

The adhesive layer preferably includes at least one polyurethane resin adhesive and one or more other adhesives may be used in combination with the polyurethane resin adhesive.

The thickness of the adhesive layer is preferably 3 μm to 15 μm and more preferably 3 μm to 10 μm from the viewpoint of adhesive strength and handleability when the moisture-absorbing material is formed into a packaging material. When the thickness of the adhesive layer is within the above range, both adhesive strength and handleability when the moisture-absorbing material is formed into a packaging material can be achieved at a higher level.

In addition, when the thickness within the above range is selected, the moisture-absorbing rate of the moisture-absorbing layer can be controlled.

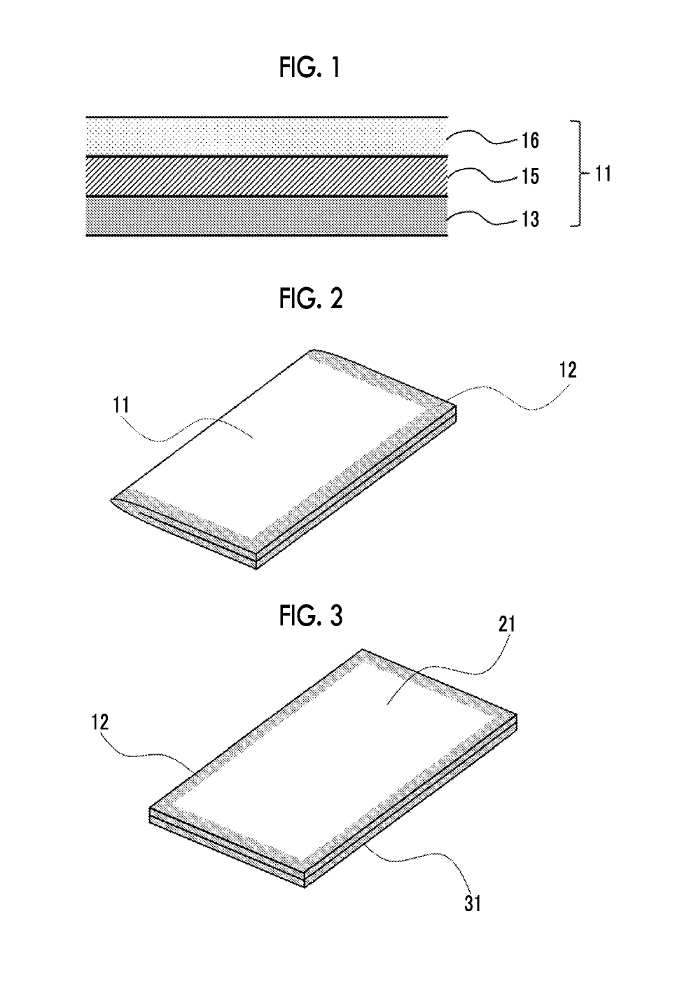

The moisture-absorbing material of the present invention may be a moisture-absorbing material 11 obtained by laminating a polymer layer 16, a moisture-absorbing layer 15, and a moisture-proof layer 13 in this order as shown in FIG. 1 and may further include an adhesive layer formed between the moisture-absorbing layer and the moisture-proof layer by applying an adhesive between the moisture-absorbing layer 15 and the moisture-proof layer 13.

<Method for Manufacturing Moisture-Absorbing Material>

The method for manufacturing a moisture-absorbing material of the present invention includes a step of forming a moisture-absorbing layer by forming a layer having a porous structure by applying a coating liquid including amorphous silica having an average secondary particle diameter of 10 μm or less and a water-soluble resin to any one of a moisture-permeable polymer layer and a moisture-proof layer and applying a solution including a moisture-absorbing agent to the porous structure to impregnate the porous structure with the moisture-absorbing agent (moisture-absorbing layer forming step), and a step of laminating the other one of the polymer layer and the moisture-proof layer on the moisture-absorbing layer impregnated with the moisture-absorbing agent (lamination step).

In the moisture-absorbing layer configured to have a porous structure using amorphous silica, the moisture-absorbing agent is adsorbed onto the surface of the silica forming the porous structure by applying the moisture-absorbing agent. Thus, a wide hygroscopic surface can be secured in the moisture-absorbing material and the moisture-absorbing material has a high moisture-absorbing rate and a large moisture absorption capacity. Particularly, when the porous structure is formed with vapor phase process silica, transparency is imparted and thus the moisture-absorbing material has light transmittance (that is, visibility through a material).

—Moisture-Absorbing Layer Forming Step—

The moisture-absorbing layer forming step in the present invention is a step of forming a moisture-absorbing layer by forming a layer having a porous structure by applying a coating liquid including amorphous silica having an average secondary particle diameter of 10 μm or less and a water-soluble resin to any one of a moisture-permeable polymer layer and a moisture-proof layer and applying a solution including a moisture-absorbing agent to the porous structure to impregnate the porous structure with the moisture-absorbing agent.

(Layer Having Porous Structure Formation)

The coating liquid can be prepared by mixing amorphous silica, water-soluble resin, and as required, other components such as a dispersing agent, water, and a crosslinking agent, and dispersing the mixture.

For example, vapor phase process silica particles as a pigment and a dispersing agent are added in water and dispersed using a high-speed rotation wet colloid mill (for example, CLEAMIX, manufactured by M Technique Co., Ltd.) or a liquid-liquid collision dispersing machine (ULTIMIZER, manufactured by Sugino Machine Limited), for example, under the conditions of a high-speed rotation of 10,000 rpm (preferably, from 5,000 to 20,000 rpm) for a predetermined period of time (preferably, from 10 minutes to 30 minutes), and then, a crosslinking agent (for example, boric acid), a water-soluble resin (preferably an aqueous polyvinyl alcohol solution) are added. Further, other components are added as required and the resultant mixture is dispersed under the same rotation conditions as described above, thereby preparing a coating liquid.

The obtained coating liquid in a highly homogeneous sol state, and a moisture-absorbing layer with a porous structure having a three-dimensional network structure can be formed by applying the coating liquid to a supporter by a coating method and drying the applied coating liquid.

In addition, a water dispersion containing amorphous silica and a dispersing agent is prepared as follows. An amorphous silica water dispersion liquid may be prepared in advance and the water dispersion liquid may be added to an aqueous dispersing agent solution. An aqueous dispersing agent solution may be added to an amorphous silica water dispersion liquid or the aqueous dispersing agent solution and the amorphous silica water dispersion liquid may be simultaneously mixed. Further, instead of the amorphous silica water dispersion liquid, powder amorphous silica may be added to the aqueous dispersing agent solution as described above.

After the amorphous silica and the dispersing agent are mixed, the obtained liquid mixture particles are refined using a dispersing machine so that a water dispersion liquid having an average particle diameter of 20 nm to 5,000 nm can be obtained. Particularly, when vapor phase process silica is used as the amorphous silica, a water dispersion liquid having an average particle diameter of 20 nm to 100 nm can be obtained.

Various kinds of conventional dispersing machines such as a high speed rotating dispersing machine, a medium stirring type dispersing machine (ball mill, sand mill, and the like), an ultrasonic dispersing machine, a colloid mill dispersing machine, or a high pressure dispersing machine can be used. Among these, a stirring type dispersing machine, a colloid mill dispersing machine, and a high pressure dispersing machine are preferable as the dispersing machine.

In the preparation of the coating liquid, a solvent can be used. Examples of the solvent include water, an organic solvent and a mixed solvent formed of water and an organic solvent. Examples of the organic solvent include alcohols such as methanol, ethanol, n-propanol, i-propanol, and methoxypropanol, ketones such as acetone and methylethylketone, tetrahydrofuran, acetonitrile, ethyl acetate, and toluene.

Coating can be carried out by, for example, known coating methods using a bread coater, an air knife coater, a roll coater, a bar coater, a gravure coater, and a reverse coater.

After the coating liquid is applied, the coating liquid is dried until the moisture-absorbing layer exhibits falling-rate drying. Generally, drying can be performed within a temperature range of 40° C. to 180° C. and a time range of 0.5 minutes to 10 minutes (preferably 0.5 minutes to 5 minutes).

When the moisture-absorbing layer having a porous structure is formed, the coating liquid is applied and dried to form a layer having a porous structure (coating layer). Then, a basic compound-containing solution may be applied to the formed layer. In this manner, a moisture-absorbing layer with a porous structure having a satisfactory pore structure can be obtained.

As the method for applying the basic compound-containing solution, a method for applying the basic compound-containing solution to the moisture-absorbing layer, a method for spraying the basic compound-containing solution using a spray or the like, a method for immersing a supporter having a coating layer formed in the basic compound-containing solution, and the like can be used.

The basic compound-containing solution contains at least one basic compound.

Examples of the basic compound include ammonium salts of weak acids, alkali metal salts of weak acids (such as lithium carbonate, sodium carbonate, potassium carbonate, lithium acetate, sodium acetate and potassium acetate), alkaline earth metal salts of weak acids (such as magnesium carbonate, barium carbonate, magnesium acetate and barium acetate), ammonium hydroxide, primary to tertiary amines (such as triethylamine, tripropylamine, tributylamine, trihexylamine, dibutylamine and butylamine), primary to tertiary anilines (such as diethylaniline, dibutylaniline, ethylaniline and aniline) and pyridines which may have a substituent (such as 2-aminopyridine, 3-aminopyridine, 4-aminopyridine and 4-(2-hydroxyethyl)-aminopyridine).

Any of the above basic compounds may be used in combination with another basic substance and/or a salt thereof. Examples of another basic substance include ammonia, primary amines such as ethylamine and polyallylamine, secondary amines such as dimethylamine, tertiary amines such as N-ethyl-N-methylbutylamine, hydroxides of alkali metals and hydroxides of alkaline earth metals.

Among these, an ammonium salt of a weak acid is particularly preferred. The weak acid may be an inorganic or organic acid having a pKa value of 2 or more, and are described in, for example, Handbook of Chemistry; Fundamental Volume II (published by Maruzen Co., Ltd.). Examples of the ammonium salts of weak acids include ammonium carbonate, ammonium hydrogen carbonate, ammonium borate, ammonium acetate and ammonium carbamate. However, the ammonium salts of weak acids are not limited thereto. Among these, ammonium carbonate, ammonium hydrogen carbonate and ammonium carbamate are preferable, and are effective in that these compounds do not remain in the layer after drying and the ink bleed can be reduced. The basic compound may be used in combination of two or more thereof

The content of the basic compound (particularly an ammonium salt of a weak acid) in the “basic compound-containing solution” is preferably from 0.5% by mass to 10% by mass, and more preferably from 1% by mass to 5% by mass, with respect to the total mass (including the solvent) of the “basic compound-containing solution”. When the content of the basic compound (particularly an ammonium salt of a weak acid) is within the above range, a sufficient degree of curing can be obtained and impairment of a working environment caused by an excessively high ammonia concentration can be avoided.

The basic compound-containing solution can further contain a metal compound, a crosslinking agent, another mordant component, a surfactant and the like as required.

The curing of the film is promoted by using the basic compound-containing solution as an alkali solution. The pH of the basic compound-containing solution (25° C.) is preferably 7.1 or higher, more preferably 8.0 or higher, and still more preferably 9.0 or higher. When the pH is 7.1 or higher, the crosslinking reaction of the water-soluble resin included in the coating liquid is further promoted and cracking of the layer is more effectively suppressed.

The basic compound-containing solution can be prepared, for example, by adding a crosslinking agent (such as a boron compound, in an amount of, for example, from 0.1% by mass to 1% by mass) and a basic compound (such as ammonium carbonate, in an amount of, for example, from 1% by mass to 10% by mass), and, as required, an additive such as a surfactant to ion exchange water, and then stirring the components.

As the coating method for applying the basic compound-containing solution, the same methods as the coating methods of the coating liquid used for forming the moisture-absorbing layer can be used. Among these, when the basic compound-containing solution is applied, it is preferable that a method in which a coater is not directly brought into contact with a coating layer formed by the application is selected.

Regarding the amount of the basic compound-containing solution applied, from the viewpoint of moisture absorbing performance of the moisture-absorbing layer, the amount of the moisture-absorbing agent applied is preferably 1 g/m² or more and 20 g/m² or less, and the amount of the moisture-absorbing agent applied is more preferably 3 g/m² or more and 12 g/m² or less.

After the application of the basic compound-containing solution, heating is performed generally at a temperature of 40° C. to 180° C. for 0.5 minutes to 30 minutes and drying and curing are performed. Among these, it is preferable that heating is performed at a temperature of 40° C. to 150° C. for 1 minute to 20 minutes. For example, when the solution contains borax and boric acid as boron compounds, it is preferable that heating is performed at a temperature of 60° C. to 100° C. for 0.5 minutes to 15 minutes.

The basic compound-containing solution and the coating liquid for forming a moisture-absorbing layer may be simultaneously applied. In this case, the coating liquid and the basic compound-containing solution are simultaneously applied to the supporter such that the coating liquid is brought into contact with the supporter (multilayer coating), and then dried and cured. Thus, a layer having a porous structure can be formed.

The simultaneous coating (multilayer coating) can be performed by a coating method using an extrusion die coater, a curtain flow coater or the like. The coating layer formed after the simultaneous coating is dried. In this case, drying is performed by heating the coating layer generally at a temperature of 40° C. to 150° C. for 0.5 minutes to 10 minutes. Heating is preferably performed at a temperature of 40° C. to 100° C. for 0.5 minutes to 5 minutes. For example, when borax and boric acid are used as the crosslinking agent containing the basic compound-containing solution, heating is preferably performed at a temperature of 60° C. to 100° C. for 5 minutes to 20 minutes.

(Moisture-Absorbing Layer Formation)

As described above, the moisture-absorbing layer is formed by forming a layer having a porous structure and then applying a solution including a moisture-absorbing agent to this layer to impregnate the porous structure with the moisture-absorbing agent.

As the method for applying the solution including a moisture-absorbing agent, a method for applying the solution to the moisture-absorbing layer, a method for spraying the solution using a spray or the like, a method for immersing the layer having a porous structure in a solution, and the like can be used.

As a coating method when the solution including a moisture-absorbing agent is applied by coating, the same coating methods as the coating methods of the coating liquid for forming a moisture-absorbing layer can be used.

The solution including a moisture-absorbing agent contains at least one moisture-absorbing agent and may contain other components such as a surfactant or a medium as required.

The solution including a moisture-absorbing agent can be prepared, for example, by adding a moisture-absorbing agent (for example, an inorganic salt) and an additive such as a surfactant as required to ion exchange water, and then stirring the components.

Regarding the amount of the solution including a moisture-absorbing agent applied, from the viewpoint of the amount of moisture absorption and the moisture-absorbing rate of the moisture-absorbing layer, the amount of the moisture-absorbing agent applied is preferably 1 g/m² or more and 20 g/m² or less, and the amount of the moisture-absorbing agent applied is more preferably 3 g/m² or more and 12 g/m² or less.

After the solution including a moisture-absorbing agent is applied, heating is performed generally at a temperature of 40° C. to 180° C. for 0.5 minutes to 30 minutes and drying and curing are performed. Among these, it is preferable that heating is performed at a temperature of 40° C. to 150° C. for 1 minute to 20 minutes. For example, when the above-described solution contains borax and boric acid as boron compounds, heating is preferably performed at a temperature of 60° C. to 100° C. for 0.5 minutes to 15 minutes.

—Lamination Step—

In the lamination step in the present invention, the other one of the above-described polymer layer and the moisture-proof layer is laminated on the moisture-absorbing layer formed by impregnation with the moisture-absorbing agent in the above-described moisture-absorbing layer forming step.

For example, a formation method for the moisture-proof layer (or the polymer layer) is not particularly limited and may be formed by bonding a material having moisture-proof properties (or a material having moisture permeability) onto the moisture-absorbing layer provided on the polymer layer (or the moisture-proof layer). In addition, the moisture-proof layer (or the polymer layer) may be formed by preparing a coating liquid including a material having moisture-proof properties (or a material having moisture permeability) and applying the coating liquid to the moisture-absorbing layer.

<Packaging Material>

The moisture-absorbing material in the present invention may be used as a packaging material and the shape of the packaging material may be a bag-like shape.

When the moisture-absorbing material is used as a packaging material, the moisture-absorbing material may be used as embodiments shown below.

A packaging material according to a first embodiment of the present invention may be formed such that an adhesion site in which a part of a polymer layer of one moisture-absorbing material A is bonded with another part of the moisture-absorbing material A is provided and the moisture-absorbing material is placed inside a packaging.

A packaging material according to a second embodiment of the present invention may be formed such that an adhesion site in which a part of a polymer layer of a first moisture-absorbing material which is selected from plural moisture-absorbing materials is bonded with a part of a second moisture-absorbing material which is different from the first moisture-absorbing material is provided and the moisture-absorbing material is placed inside a packaging.

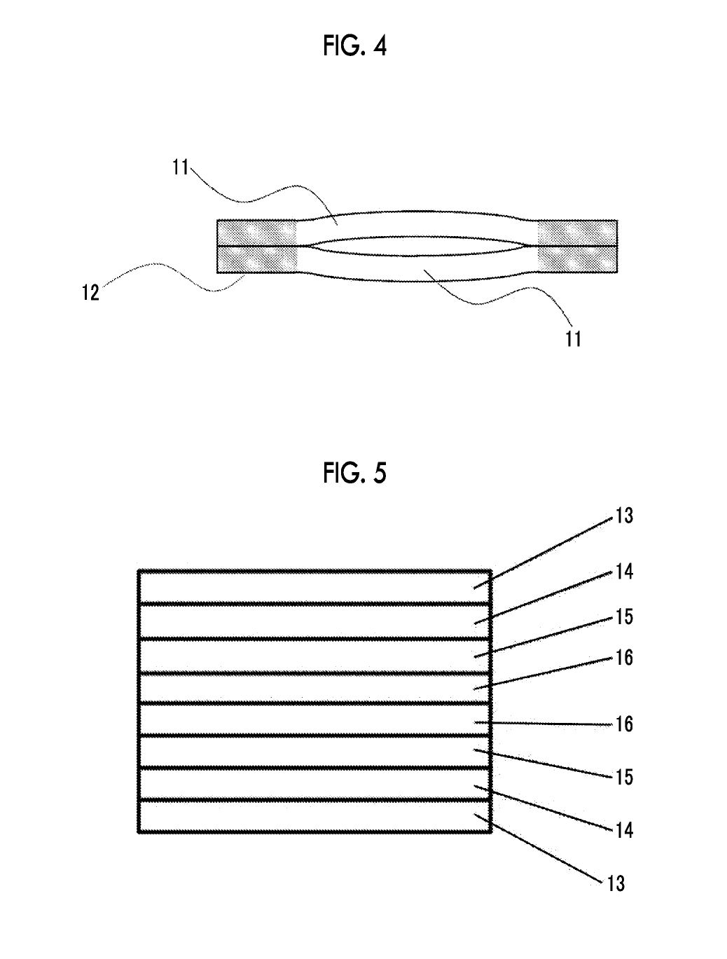

The moisture-absorbing material in the present invention may be used, for example, as shown in FIG. 2, by folding one sheet of the moisture-absorbing material 11, and bonding a part of the polymer layer of the moisture-absorbing material 11 with another part of the moisture-absorbing material 11 into a bag-like shape. In this case, as shown in FIGS. 4 and 5, the polymer layers 16 that are overlapped by folding one sheet of the moisture-absorbing material 11 can be bonded with each other into a bag-like shape by thermocompression bonding or the like. An adhesion site 12 shown in FIGS. 2 to 4 has a configuration in which the moisture-proof layer 13, the adhesive layer 14, the moisture-absorbing layer 15, and the polymer layer 16 are laminated as shown in FIG. 5. FIG. 5 is an enlarged sectional view showing the layer constitution of the adhesion site 12 in FIG. 4 in an enlarged manner.

As shown in FIG. 3, the moisture-absorbing material may be used by bonding a part of a polymer layer of a first moisture-absorbing material 21 which is selected from plural moisture-absorbing materials with a part of a second moisture-absorbing material 31 which is different from the first moisture-absorbing material 21 into a bag-like shape. In this case, two sheets of moisture-absorbing materials are overlapped so that the polymer layers 16 of the two sheets of moisture-absorbing materials are brought into contact with each other. Heat is applied from the side closer to the moisture-proof layer of one side of the moisture-absorbing material (for example, the moisture-absorbing material 21) and the polymer layers are bonded with each other into a bag-like shape by thermocompression bonding or the like.

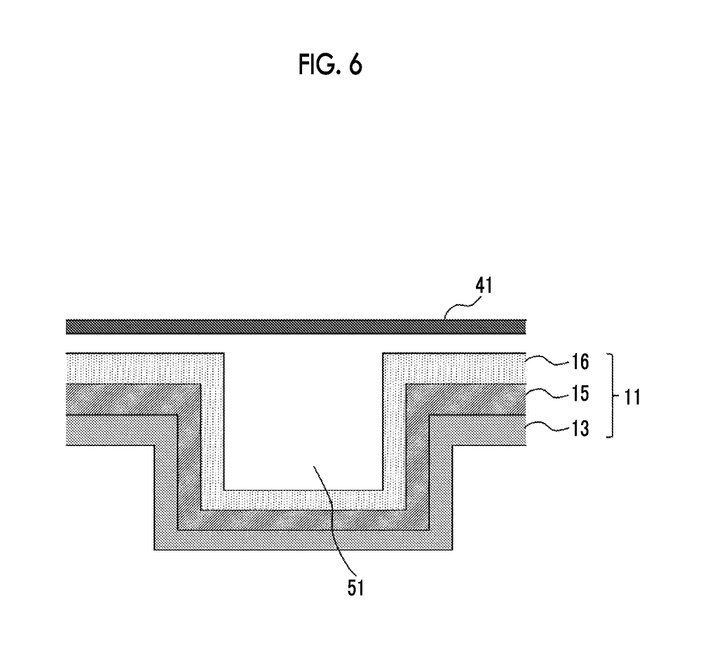

Further, as another example of the packaging material, as shown in FIG. 6, a packaging material may be configured to have the moisture-absorbing material 11 in which a concave portion 51 which becomes a storage portion is formed by forming the moisture-absorbing material 11 in advance and a plate-like counter substrate 41 which is bonded with the polymer layer 16 in a portion in which a concave portion is not formed on the side closer to the opening surface of the concave portion 51 of the moisture-absorbing material 11. In this case, a packaging material having a storage portion can be formed by applying heat from the side of the moisture-proof layer 13 of the moisture-absorbing material 11 for compression bonding or the like and bonding the moisture-absorbing material 11 and the counter substrate 41.

Specifically, the packaging material of the present invention is used as a blister pack (also referred to as PTP packaging) used for packaging of drugs and the like.

The application of heat can be performed by bringing a heated rod or plate into contact with the layers for heating or by impulse sealing and ultrasonic sealing in addition to hot plate sealing by heating compression bonding.

### EXAMPLES

In the following, the present invention will be described in more detail with reference to examples. However, the present invention is not limited to these examples. Moreover, the term “part(s)” is based on “part(s) by mass” unless specifically stated otherwise.

### Example 1

### Moisture-Absorbing Layer Formation

—Preparation of Coating Liquid for Forming Moisture-Absorbing Layer—

(1) Vapor phase process silica 1, (2) ion exchange water, (3) SHAROL DC-902P, and (4) ZIRCOSOL ZA-30 shown in the following composition were mixed. The mixture was dispersed using a liquid-liquid impact type dispersing machine (ULTIMAIZER, manufactured by Sugino Machine Limited) (this step is appropriately referred to as a silica dispersion treatment), and then, the obtained dispersion liquid was heated to 45° C. and maintained for 20 hours. Thereafter, the temperature of the dispersion liquid was maintained at 30° C. and (5) an aqueous boric acid solution and (6) a polyvinyl alcohol (PVA) solution were added to the dispersion liquid. Thus, a coating liquid for forming a moisture-absorbing layer was prepared.

(Composition of Coating Liquid for Forming Moisture-Absorbing Layer)

| | | |
|---|---|---|
| (1) | Vapor phase process silica 1 (amorphous silica) | 8.9 parts |
| | (AEROSIL 300SF75, manufactured by Nippon Aerosil | |
| | Co., Ltd., average primary particle diameter: 7 nm, | |
| | average secondary particle diameter: 20 nm) | |
| (2) | Ion exchange water | 47.3 parts |
| (3) | “SHAROL DC-902P” (51.5% aqueous solution) | 0.8 parts |
| | (dispersing agent, nitrogen-containing organic | |
| | cationic polymer, manufactured by DKS Co., Ltd.) | |
| (4) | “ZIRCOSOL ZA-30” (manufactured by Daiichi | 0.5 parts |
| | Kigenso Kagaku Kogyo Co., Ltd., zirconyl acetate) | |
| (5) | Boric acid (5% aqueous solution) | 6.6 parts |
| (6) | Polyvinyl alcohol (water-soluble resin) solution | 26.0 parts |

—Composition of Polyvinyl Alcohol Solution—

| | |
|---|---|
| JM33 (polyvinyl alcohol; saponification degree: | 1.81 parts |
| 95.5%, polymerization degree: 3,300, manufactured | |
| by Japan Vam & Poval Co., Ltd.) | |
| HPC-SSL (water-soluble cellulose, manufactured | 0.08 parts |
| by Nippon Soda Co., Ltd.) | |
| Ion exchange water | 23.5 parts |
| Diethyleneglycol monobutylether (BUTYCENOL 20P, | 0.55 parts |
| manufactured by Kyowa Hakko Chemical Co., Ltd.) | |
| Polyoxyethylene lauryl ether (surfactant) | 0.06 parts |
| (“EMULGEN 109P”, manufactured by Kao Corporation) | |

—Moisture-Absorbing Layer Formation—

As the polymer layers, sheets of linear low density polyethylene (LLDPE) (hereinafter, also referred to as LLDPE sheets) having thicknesses shown in Table 1 shown below were prepared. Each LLDPE sheet was coated with the coating liquid for forming a moisture-absorbing layer obtained in the above description using an extrusion die coater such that the coating amount became 165 g/m².

The coating layer formed by coating was dried with a hot air dryer at 80° C. (air flow rate of 3 m/second to 8 m/second) until the concentration of the solid content of the coating layer became 36%. The coating layer exhibited a constant drying rate during the drying. Immediately after the drying, the coating layer was immersed for 3 seconds into a liquid that contains a basic compound and that has the following composition to attach the liquid in an amount of 13 g/m² to the coating layer. The resultant was further dried at 72° C. for 10 minutes, and thus, a layer having a porous structure was formed.

Thereafter, a moisture-absorbing agent coating liquid having the composition shown below was applied to the formed layer using an extrusion die coater such that the coating amount became 50 g/m² (the amount of CaCl₂ applied: 7 g/m²), and the coating layer was dried with a hot air dryer at 80° C. (air flow rate of 3 m/second to 8 m/second). Thus, a moisture-absorbing layer having a thickness of 40 μm was obtained.

The formed moisture-absorbing layer had a void volume of 60% and an average pore diameter of 20 nm.

(Composition of Basic Compound-Containing Solution)

| | | |
|---|---|---|
| (1) | Boric acid | 0.65 parts |
| (2) | Ammonium carbonate (First grade: manufactured | 5.0 parts |
| | by Kanto Chemical Co., Inc.) | |
| (3) | Ion exchange water | 93.75 parts |
| (4) | Polyoxyethylene lauryl ether (surfactant) | 0.6 parts |
| | (“EMULGEN 109P”, manufactured by Kao | |
| | Corporation) | |

(Composition of Moisture-Absorbing Agent Coating Liquid)

| | | |
|---|---|---|
| (1) | Ion exchange water | 85.4 parts |
| (2) | Calcium chloride (CaCl₂; moisture-absorbing agent) | 14 parts |
| (3) | Polyoxyethylene lauryl ether (surfactant) | 0.6 parts |
| | (“EMULGEN 109P”, manufactured by Kao | |
| | Corporation) | |

—Bonding of Moisture-Proof Layer—

An adhesive (polyurethane resin adhesive: LIS-073-50U, curing agent: CR-001) manufactured by TOYO INK CO., LTD. was applied to the silica-deposited surface of a silica-deposited PET (TECH BARRIER MX, manufactured by Mitsubishi Plastics, Inc.) which is a moisture-proof layer such that the coating amount after drying became the thickness shown in Table 1 below, and the side closer to the moisture-absorbing layer formed surface on the polymer layer on which the moisture-absorbing layer was formed was brought into contact with the adhesive. Then, the polymer layer was laminated on the silica-deposited PET and bonded with silica-deposited PET using a dry laminator. In this manner, a moisture-absorbing material of the present invention was obtained.

The obtained moisture-absorbing material has a structure in which the LLDPE sheet, the moisture-absorbing layer, the adhesive layer, and the (deposited surface) silica-deposited PET are laminated.

In Table 1 below, for example, an adhesive coating amount of 3 g/m² corresponds to an adhesive thickness of 3 μm and an adhesive coating amount of 15 g/m² corresponds to an adhesive thickness of 15 μm, respectively. In Table 1, the unit of numerical values in the column of “Thickness of adhesive” is “μm”.

—Moisture-Absorbing Material Formation—

The moisture-absorbing material obtained in the above process was interposed between concave and convex portions, was pre-heated at 130° C. for 2 seconds using a hot plate and then heated to 100° C. and thus a molded article in which a concave storage portion is formed as shown in FIG. 6 was prepared.

—Evaluation—

The thus-obtained moisture-absorbing material and molded article were subjected to the following evaluations. The evaluation results are shown in Table 1 below.

<Average Pore Diameter>

The average pore diameter was measured by the mercury intrusion method using Shimadzu AUTOPORE 9220 (manufactured by Shimadzu Corporation).

<Measurement of Particle Diameter>

The surface of the obtained moisture-absorbing layer was observed with an electron microscope (JEM 2100, manufactured by JEOL Ltd.) and the projection area of each of 100 silica particles at an arbitrary position on the surface was obtained. When a circle having an area equal to the projected area is assumed, the individual particle diameter was obtained and the diameters of 100 silica particles were simply averaged, thereby obtaining an average primary particle diameter.

In addition, the surface of the obtained moisture-absorbing layer was observed with an electron microscope (S-4700, manufactured by HITACHI Ltd.) at an accelerating voltage of 10 kV and the projection area of each of 100 aggregated particles at an arbitrary position on the surface was obtained. When a circle having an area equal to the projected area is assumed, each particle diameter was obtained and the diameters of 100 aggregated particles were simply averaged, thereby obtaining an average secondary particle diameter.

<Transparency>

The total light transmittance of the moisture-absorbing material was measured using a haze meter HGM-2DP (manufactured by Suga Test Instruments Co., Ltd.) and was evaluated based on the following criteria.

<Evaluation Criteria>

A: The total light transmittance was 80% or more.
B: The total light transmittance was 70% or more and less than 80%.
C: The total light transmittance was 60% or more and less than 70%.
D: The total light transmittance was less than 60%.

<Visibility>

In the visibility evaluation of the moisture-absorbing material, with respect to each of a yellow ink, a magenta ink, a cyan ink, and a black ink, an image in which characters “ [symbol] ” of 12 points in Mincho typeface are arranged was disposed on the side closer to the polymer layer of the moisture-absorbing material and the visibility of the character “ [symbol] ” when viewed from the side closer to the moisture-proof layer was evaluated based on the following criteria.

<Evaluation Criteria>

A: Since the moisture-absorbing material was transparent, the character “ [symbol] ” could be clearly visibly recognized.
B: The character “ [symbol] ” could be visibly recognized.
C: The character “ [symbol] ” could be barely visibly recognized.
D: Since the moisture-absorbing material was not transparent, the visual recognition of the character “ [symbol] ” was difficult.

<Moisture Absorption Capacity>

The moisture absorption capacity of the moisture-absorbing material was evaluated as follows.

The moisture-absorbing material obtained in the above process was cut into 100 mm×100 mm pieces and used as samples. The sample was stored in a thermohygrostat bath at 60° C. and 10% RH for 1 hour and dried. The mass of the sample immediately after the sample was transferred to an environment of 23° C. and 50% RH was measured and the obtained mass was set to a mass in a dried state. Thereafter, a change in mass of the sample over time was measured and a moisture absorption capacity was obtained from the mass of the sample at the time when there was no change in mass of the sample.

<Evaluation Criteria>

A: The moisture absorption capacity at 23° C. and 50% RH was 10 g/m² or more.
B: The moisture absorption capacity at 23° C. and 50% RH was 6 g/m² or more and less than 10 g/m².
C: The moisture absorption capacity at 23° C. and 50% RH was 3 g/m² or more and less than 6 g/m².
D: The moisture absorption capacity at 23° C. and 50% RH was less than 3 g/m².

<Moisture-Absorbing Rate>

The moisture-absorbing rate of the obtained moisture-absorbing material was evaluated as follows.

The moisture-absorbing material obtained in the above process was cut into 100 mm×100 mm pieces and used as samples. The sample was stored in a thermohygrostat bath at 60° C. and 10% RH for 1 hour and dried. The mass of the sample immediately after the sample was transferred to an environment of 23° C. and 50% RH was measured and the obtained mass was set to a mass in a dried state. Then, the amount of water absorbed by the sample was measured from the change in mass of the sample over time and the time from the start of water absorption to the saturation of water absorption was set to a moisture-absorbing rate.

<Void Volume>

A void volume per unit thickness was calculated from the void volume (ml/m²) and the thickness (μm) of the moisture-absorbing layer of the moisture-absorbing material obtained in the above process to obtain a void volume.

Here, the thickness of the moisture-absorbing layer was obtained from the result of observation using an optical microscope. In addition, regarding the void amount of the moisture-absorbing layer, 1 ml of diethylene glycol was dropped onto the moisture-absorbing layer, the dropping surface was wiped with a cloth after one minute had passed, and a change in weight before and after dropping (the amount of liquid absorbed per unit area) was calculated. This calculated value was set to a void amount.

<Cracking>

The molded articles obtained in the above process was visually observed and the presence of cracking in the moisture-absorbing layer was evaluated based on the following evaluation criteria.

<Evaluation Criteria>

A: Cracking did not occur.
B: Very slight cracking occurred but normal handling was not interrupted.
C: Slight cracking occurred but was within an allowable range.
D: Cracking was remarkably recognized and there was a problem in practical use.

### Example 2

A moisture-absorbing layer was formed in the same manner as in Example 1 except that vapor phase process silica 2 (average primary particle diameter: 7 nm, average secondary particle diameter: 26 nm) obtained by performing a silica dispersion treatment using a bead mill dispersing machine (Dyno mill KDP, manufactured by Shinmaru Enterprises Corp.) under the following conditions instead of using the liquid-liquid impact type dispersing machine (ULTIMAIZER, manufactured by Sugino Machine Limited.) in Example 1.

(Silica Dispersion Treatment Conditions)

Kind of bead: zirconia beads

Diameter of bead: 1.0 mmφ

Bead packing rate: 80%

Peripheral velocity: 8 msec

Number of treatments: 2 times

Discharge flow rate: 590 g/min

In addition, a molded article was prepared while forming a moisture-absorbing material by bonding the moisture-proof layer as in Example 1a and evaluation was performed. The evaluation results are shown in Table 1 below.

### Example 3

A moisture-absorbing layer was formed by performing a silica dispersion treatment in the same manner as in Example 1 except that (1) vapor phase process silica 1 (AEROSIL 300SF75, manufactured by Nippon Aerosil Co., Ltd., average primary particle diameter: 7 nm) in Example 1 was changed to vapor phase process silica 3 (AEROSIL200, manufactured by Nippon Aerosil Co., Ltd., average primary particle diameter: 12 nm, average secondary particle diameter: 30 nm). In addition, a molded article was prepared while forming a moisture-absorbing material by bonding the moisture-proof layer as in Example 1 and evaluation was performed. The evaluation results are shown in Table 1 below.

### Example 4

A moisture-absorbing layer was formed in the same manner as in Example 1 except that the thickness of the polymer layer (material: LLDPE) in Example 1 was changed to 120 μm. In addition, a molded article was prepared while forming a moisture-absorbing material by bonding the moisture-proof layer as in Example 1 and evaluation was performed. The evaluation results are shown in Table 1 below.

### Example 5

A molded article was prepared while forming a moisture-absorbing material by bonding the moisture-proof layer as in Example 1a except that the coating amount of the adhesive layer in Example 1 was changed to 2 g/m² (corresponding to a thickness of 2 μm) and evaluation was performed. The evaluation results are shown in Table 1 below.

### Comparative Example 1

A moisture-absorbing layer was formed in the same manner as in Example 1a except that the moisture-absorbing agent coating liquid in Example 1 was not applied. In addition, a molded article was prepared while forming a moisture-absorbing material by bonding the moisture-proof layer as in Example 1a and evaluation was performed. The evaluation results are shown in Table 1 below.

### Comparative Example 2

A molded article was prepared while forming a moisture-absorbing layer in the same manner as in Example 1a except that (5) boric acid (5% aqueous solution) and (6) a polyvinyl alcohol (water-soluble resin) solution were removed from the coating liquid for forming a moisture-absorbing layer in Example 1 and evaluation was performed. The evaluation results are shown in Table 1 below.

### Comparative Example 3

A moisture-absorbing layer was formed in the same manner as in Example 1a except that (1) vapor phase process silica 1 (AEROSIL 300SF75, manufactured by Nippon Aerosil Co., Ltd., average primary particle diameter: 7 nm, average secondary particle diameter: 20 nm) in Example 1 was changed to silica gel (P78D, manufactured by MIZUSAWA INDUSTRIAL CHEMICALS, LTD., average secondary particle diameter: 12 μm). In addition, a molded article was prepared while forming a moisture-absorbing material by bonding the moisture-proof layer in the same manner as in Example 1a and evaluation was performed. The evaluation results are shown in Table 1 below.

TABLE 1

| | | | Moisture-absorbing layer | | | | | | | | | | | | | | | | | |
|---|---|---|---|---|---|---|---|---|---|---|---|---|---|---|---|---|---|---|---|---|
| | | | | | | | | | | | | | | | Thickness of | | | | | |
| | | Thick- | | | | | | | (Ratio | | | | | | adhesive | | | | | |
| | | ness | | | | | | | between | | | | | Average | [between | | | | | |
| | | of | | Primary | | | Saponi- | Polym- | amorphous | | | | | pore | moisture- | Evaluation | | | | |
| | | polymer | | particle | Secondary | | fication | erization | silica and) | | | | Moisture- | diam- | proof | | | Moisture | Moisture- | |
| | | layer | Kind of | diam- | particle | | degree | degree of | Amount | Thick- | Void | Crosslinking | absorbing | eter | layer and | Trans- | Visi- | absorption | absorbing | Crack- |
| | | [μm] | silica | eter | diameter | | of PVA | PVA | of PVA | ness | volume | agent | agent | [μm] | porous layer] | parency | bility | capacity | rate | ing |
| Example 1 | a | 20 | Vapor phase | 7 nm | 20 | nm | 96% | 3,300 | 20% | 40 μm | 60% | Boric acid | CaCl₂ | 20 | 3 | A | A | A | 3 Days | A |
| | | | process | | | | | | | | | | | | | | | | | |
| | | | silica 1 | | | | | | | | | | | | | | | | | |
| | b | 100 | Vapor phase | 7 nm | 20 | nm | 96% | 3,300 | 20% | 40 μm | 60% | Boric acid | CaCl₂ | 20 | 3 | A | A | A | 14 Days | A |
| | | | process | | | | | | | | | | | | | | | | | |
| | | | silica 1 | | | | | | | | | | | | | | | | | |
| | c | 20 | Vapor phase | 7 nm | 20 | nm | 96% | 3,300 | 20% | 40 μm | 60% | Boric acid | CaCl₂ | 20 | 15 | A | A | A | 3 Days | A |
| | | | process | | | | | | | | | | | | | | | | | |
| | | | silica 1 | | | | | | | | | | | | | | | | | |
| | d | 100 | Vapor phase | 7 nm | 20 | nm | 96% | 3,300 | 20% | 40 μm | 60% | Boric acid | CaCl₂ | 20 | 15 | A | A | A | 14 Days | A |
| | | | process | | | | | | | | | | | | | | | | | |
| | | | silica 1 | | | | | | | | | | | | | | | | | |
| Example 2 | | 20 | Vapor phase | 7 nm | 26 | nm | 96% | 3,300 | 20% | 42 μm | 61% | Boric acid | CaCl₂ | 24 | 3 | B | B | A | 3 Days | A |
| | | | process | | | | | | | | | | | | | | | | | |
| | | | silica 2 | | | | | | | | | | | | | | | | | |
| | | | (dispersing | | | | | | | | | | | | | | | | | |
| | | | machine | | | | | | | | | | | | | | | | | |
| | | | changed) | | | | | | | | | | | | | | | | | |
| Example 3 | a | 20 | Vapor phase | 12 nm | 30 | nm | 96% | 3,300 | 20% | 43 μm | 62% | Boric acid | CaCl₂ | 27 | 3 | C | C | A | 3 Days | A |
| | | | process | | | | | | | | | | | | | | | | | |
| | | | silica 3 | | | | | | | | | | | | | | | | | |
| | b | 100 | Vapor phase | 12 nm | 30 | nm | 96% | 3,300 | 20% | 43 μm | 62% | Boric acid | CaCl₂ | 27 | 3 | C | C | A | 14 Days | A |
| | | | process | | | | | | | | | | | | | | | | | |
| | | | silica 3 | | | | | | | | | | | | | | | | | |
| | c | 20 | Vapor phase | 12 nm | 30 | nm | 96% | 3,300 | 20% | 43 μm | 62% | Boric acid | CaCl₂ | 27 | 15 | A | A | A | 3 Days | A |
| | | | process | | | | | | | | | | | | | | | | | |
| | | | silica 3 | | | | | | | | | | | | | | | | | |
| | d | 100 | Vapor phase | 12 nm | 30 | nm | 96% | 3,300 | 20% | 43 μm | 62% | Boric acid | CaCl₂ | 27 | 15 | A | A | A | 14 Days | A |
| | | | process | | | | | | | | | | | | | | | | | |
| | | | silica 3 | | | | | | | | | | | | | | | | | |
| Example 4 | | 120 | Vapor phase | 7 nm | 20 | nm | 96% | 3,300 | 20% | 40 μm | 60% | Boric acid | CaCl₂ | 20 | 3 | A | A | A | 16 Days | A |
| | | | process | | | | | | | | | | | | | | | | | |
| | | | silica 1 | | | | | | | | | | | | | | | | | |
| Example 5 | | 20 | Vapor phase | 7 nm | 20 | nm | 96% | 3,300 | 20% | 40 μm | 60% | Boric acid | CaCl₂ | 20 | 2 | A | A | A | 3 Days | A |
| | | | process | | | | | | | | | | | | | | | | | |
| | | | silica 1 | | | | | | | | | | | | | | | | | |
| Com- | | 20 | Vapor phase | 7 nm | 20 | nm | 96% | 3,300 | 20% | 40 μm | 63% | Boric acid | — | 20 | 3 | A | A | D | 3 Days | B |
| parative | | | process | | | | | | | | | | | | | | | | | |
| Example 1 | | | silica 1 | | | | | | | | | | | | | | | | | |

| | | | | | | | | | | | | | | | | |
|---|---|---|---|---|---|---|---|---|---|---|---|---|---|---|---|---|
| Com- | 20 | Vapor phase | 7 nm | 20 | nm | — | — | 0% | — | — | None | CaCl₂ | — | — | Film formation failed | D |
| parative | | process | | | | | | | | | | | | | | |
| Example 2 | | silica 1 | | | | | | | | | | | | | | |

| | | | | | | | | | | | | | | | | | | | |
|---|---|---|---|---|---|---|---|---|---|---|---|---|---|---|---|---|---|---|---|
| Com- | 20 | Silica gel | — | 12 | μm | 96% | 3,300 | 20% | 50 μm | 70% | None | CaCl₂ | 45 | 3 | D | D | A | 3 Days | A |
| parative | | | | | | | | | | | | | | | | | | | |
| Example 3 | | | | | | | | | | | | | | | | | | | |

As shown in Table 1, it is found that in Examples, the moisture-absorbing materials have excellent transparency and visibility and a large moisture absorption capacity. Further, it is found that the moisture-absorbing rate can be controlled by changing the thickness of the polymer layer.

In contrast, it is found that in Comparative Example 1 in which the moisture-absorbing agent is not used, the moisture absorption capacity is small and both satisfactory transparency and moisture absorption capacity cannot be obtained. In addition, it is found that in Comparative Example 2 in which the water-soluble resin and the crosslinking agent are not used, the moisture-absorbing layer cannot be formed and in Comparative Example 3 using the coarse silica gel for the moisture-absorbing layer, the secondary particle diameter is large and thus the transparency and visibility were deteriorated.

### Example 6

A moisture-absorbing layer having a thickness of 40 μm was formed in the same procedure as in Example 1 by applying the coating liquid for forming a moisture-absorbing layer prepared in the same manner as in Example 1 to the silica-deposited surface of the silica-deposited PET (TECH BARRIER MX, manufactured by Mitsubishi Plastics, Inc.), which is a moisture-proof layer, using an extrusion die coater such that the coating amount became 165 g/m². In addition, as the polymer layer, a LLDPE sheet having a thickness shown in Table 2 below was prepared. To this LLDPE sheet, an adhesive (polyurethane resin adhesive: LIS-073-50U, curing agent: CR-001) manufactured by TOYO INK CO., LTD was applied so that the coating amount after drying became the thickness shown in Table 2 below. The side closer to the moisture-absorbing layer formed surface on the moisture-proof layer in which the moisture-absorbing layer was formed was brought into contact with the adhesive, the moisture-proof layer was laminated on the silica-deposited PET and bonded with silica-deposited PET using a dry laminator. In this manner, a moisture-absorbing material of the present invention was obtained. Further, a molded article was prepared.

The obtained moisture-absorbing material has a structure in which the LLDPE sheet, the adhesive layer, the moisture-absorbing layer, and the (deposited surface) silica-deposited PET are laminated.

The obtained moisture-absorbing material and molded article were evaluated in the same manner as in Example 1. The evaluation results are shown in Table 2 below.

### Example 7

A moisture-absorbing layer was formed in the same manner as in Example 6 except that vapor phase process silica 2 obtained by performing a silica dispersion treatment in the same manner as in Example 2 was used in Example 6.

In addition, a molded article was prepared while forming a moisture-absorbing material by bonding the polymer layer in the same manner as in Example 6a and evaluation was performed in the same manner as in Example 1. The evaluation results are shown in Table 2.

### Example 8

A moisture-absorbing layer was formed by performing a silica dispersion treatment in the same manner as in Example 6 except that (1) vapor phase process silica 1 in Example 6 was changed to vapor phase process silica 3 (AEROSIL200, manufactured by Nippon Aerosil Co., Ltd., average primary particle diameter: 12 nm, average secondary particle diameter: 30 nm). In addition, a molded article was prepared while forming a moisture-absorbing material by bonding the polymer layer in the same manner as in Example 6 and evaluation was performed in the same manner as in Example 1. The evaluation results are shown in Table 2.

### Example 9

A molded article was prepared while forming a moisture-absorbing material in the same manner as in Example 6a except that a moisture-absorbing layer was formed in the same manner as in Example 6 and the thickness of the polymer layer was changed to 120 μm, and evaluation was performed in the same manner as in Example 1. The evaluation results are shown in Table 2.

### Example 10

A molded article was prepared while forming a moisture-absorbing material as in Example 6a except that the coating amount of the adhesive layer in Example 6 was changed to 2 g/m² (corresponding to a thickness of 2 μm) and evaluation was performed in the same manner as in Example 1. The evaluation results are shown in Table 2 below.

### Comparative Example 4

A moisture-absorbing layer was formed in the same manner as in Example 6 except that the moisture-absorbing agent coating liquid in Example 6 was not applied. In addition, a molded article was prepared while forming a moisture-absorbing material by bonding the polymer layer as in Example 6a and evaluation was performed in the same manner as in Example 1. The evaluation results are shown in Table 2 below.

### Comparative Example 5

A molded article was prepared while forming a moisture-absorbing layer in the same manner as in Example 6a except that (5) boric acid (5% aqueous solution) and (6) a polyvinyl alcohol (water-soluble resin) solution were removed from the coating liquid for forming a moisture-absorbing layer in Example 6 and evaluation was performed in the same manner as in Example 1. The evaluation results are shown in Table 2 below.

### Comparative Example 6

A moisture-absorbing layer was formed in the same manner as in Example 6 except that (1) vapor phase process silica 1 in Example 6 was changed to silica gel (P78D, manufactured by MIZUSAWA INDUSTRIAL CHEMICALS, LTD., average secondary particle diameter: 12 μm). In addition, a molded article was prepared while forming a moisture-absorbing material by bonding the polymer layer in the same manner as in Example 6a and evaluation was performed in the same manner as in Example 1. The evaluation results are shown in Table 2 below.

TABLE 2

| | | | Moisture-absorbing layer | | | | | | | | | | | | | | | | | |
|---|---|---|---|---|---|---|---|---|---|---|---|---|---|---|---|---|---|---|---|---|
| | | | | | | | | | | | | | | | Thickness | | | | | |
| | | | | | | | | | | | | | | | of | | | | | |
| | | Thick- | | | | | | | (Ratio | | | | | | adhesive | | | | | |
| | | ness | | | | | | | between | | | | | Average | [between | | | | | |
| | | of | | Primary | | | Saponi- | Polymer- | amorphous | | | | | pore | polymer | Evaluation | | | | |
| | | polymer | | particle | Secondary | | fication | ization | silica and) | | Void | | Moisture- | diam- | layer and | | | Moisture | Moisture- | |
| | | layer | Kind of | diam- | particle | | degree | degree of | Amount | | vol- | Crosslinking | absorbing | eter | porous | Trans- | Visi- | absorption | absorbing | Crack- |
| | | [μm] | silica | eter | diameter | | of PVA | PVA | of PVA | Thickness | ume | agent | agent | [μm] | layer] | parency | bility | capacity | rate | ing |
| Example 6 | a | 20 | Vapor phase | 7 nm | 20 | nm | 96% | 3,300 | 20% | 40 μm | 60% | Boric acid | CaCl₂ | 20 | 3 | A | A | A | 4 Days | A |
| | | | process silica 1 | | | | | | | | | | | | | | | | | |
| | b | 100 | Vapor phase | 7 nm | 20 | nm | 96% | 3,300 | 20% | 40 μm | 60% | Boric acid | CaCl₂ | 20 | 3 | A | A | A | 15 Days | A |
| | | | process silica 1 | | | | | | | | | | | | | | | | | |
| | c | 20 | Vapor phase | 7 nm | 20 | nm | 96% | 3,300 | 20% | 40 μm | 60% | Boric acid | CaCl₂ | 20 | 15 | A | A | A | 6 Days | A |
| | | | process silica 1 | | | | | | | | | | | | | | | | | |
| | d | 100 | Vapor phase | 7 nm | 20 | nm | 96% | 3,300 | 20% | 40 μm | 60% | Boric acid | CaCl₂ | 20 | 15 | A | A | A | 17 Days | A |
| | | | process silica 1 | | | | | | | | | | | | | | | | | |
| Example 7 | | 20 | Vapor phase | 7 nm | 26 | nm | 96% | 3,300 | 20% | 42 μm | 61% | Boric acid | CaCl₂ | 24 | 3 | B | B | A | 4 Days | A |
| | | | process silica | | | | | | | | | | | | | | | | | |
| | | | 2 (dispersing | | | | | | | | | | | | | | | | | |
| | | | machine | | | | | | | | | | | | | | | | | |
| | | | changed) | | | | | | | | | | | | | | | | | |
| Example 8 | a | 20 | Vapor phase | 12 nm | 30 | nm | 96% | 3,300 | 20% | 43 μm | 62% | Boric acid | CaCl₂ | 27 | 3 | C | C | A | 4 Days | A |
| | | | process silica 3 | | | | | | | | | | | | | | | | | |
| | b | 100 | Vapor phase | 12 nm | 30 | nm | 96% | 3,300 | 20% | 43 μm | 62% | Boric acid | CaCl₂ | 27 | 3 | C | C | A | 15 Days | A |
| | | | process silica 3 | | | | | | | | | | | | | | | | | |
| | c | 20 | Vapor phase | 12 nm | 30 | nm | 96% | 3,300 | 20% | 43 μm | 62% | Boric acid | CaCl₂ | 27 | 15 | A | A | A | 6 Days | A |
| | | | process silica 3 | | | | | | | | | | | | | | | | | |
| | d | 100 | Vapor phase | 12 nm | 30 | nm | 96% | 3,300 | 20% | 43 μm | 62% | Boric acid | CaCl₂ | 27 | 15 | A | A | A | 17 Days | A |
| | | | process silica 3 | | | | | | | | | | | | | | | | | |
| Example 9 | | 120 | Vapor phase | 7 nm | 20 | nm | 96% | 3,300 | 20% | 40 μm | 60% | Boric acid | CaCl₂ | 20 | 3 | A | A | A | 16 Days | A |
| | | | process silica 1 | | | | | | | | | | | | | | | | | |
| Example | | 20 | Vapor phase | 7 nm | 20 | nm | 96% | 3,300 | 20% | 40 μm | 60% | Boric acid | CaCl₂ | 20 | 2 | A | A | A | — | A |
| 10 | | | process silica 1 | | | | | | | | | | | | | | | | | |
| Com- | | 20 | Vapor phase | 7 nm | 20 | nm | 96% | 3,300 | 20% | 40 μm | 63% | Boric acid | — | 20 | 3 | A | A | D | 3 Days | B |
| parative | | | process silica 1 | | | | | | | | | | | | | | | | | |
| example 4 | | | | | | | | | | | | | | | | | | | | |

| | | | | | | | | | | | | | | | | |
|---|---|---|---|---|---|---|---|---|---|---|---|---|---|---|---|---|
| Com- | 20 | Vapor phase | 7 nm | 20 | nm | — | — | 0% | — | — | None | CaCl₂ | — | — | Film formation failed | D |
| parative | | process silica 1 | | | | | | | | | | | | | | |
| example 5 | | | | | | | | | | | | | | | | |

| | | | | | | | | | | | | | | | | | | | |
|---|---|---|---|---|---|---|---|---|---|---|---|---|---|---|---|---|---|---|---|
| Com- | 20 | Silica gel | — | 12 | μm | 96% | 3,300 | 20% | 50 μm | 70% | None | CaCl₂ | 45 | 3 | D | D | A | 4 Days | A |
| parative | | | | | | | | | | | | | | | | | | | |
| example 6 | | | | | | | | | | | | | | | | | | | |

As shown in Table 2, it is found that in Examples, the moisture-absorbing materials have excellent transparency and visibility and a large moisture absorption capacity. Further, it is found that the moisture-absorbing rate can be controlled by changing the coating amount of the adhesive layer and the thickness of the polymer layer.

In contrast, it is found that in Comparative Example 4 in which the moisture-absorbing agent is not used, the moisture absorption capacity is small and both satisfactory transparency and moisture absorption capacity cannot be obtained. In addition, it is found that in Comparative Example 5 in which the water-soluble resin and the crosslinking agent are not used, the moisture-absorbing layer cannot be formed and in Comparative Example 6 using the coarse silica gel for the moisture-absorbing layer, the secondary particle diameter is large and thus the transparency and visibility were deteriorated.

### Examples 11 to 15

A moisture-absorbing material was obtained in the same manner as in Example 1 except that the kind and amount of polyvinyl alcohol (PVA) which is a water-soluble resin, the thickness of the moisture-absorbing layer, and the void volume in Example 1 were changed as shown in Table 3 below and boric acid which is a crosslinking agent was not used and further a molded article was prepared. The obtained moisture-absorbing material and molded article were evaluated in the same manner as in Example 1. The evaluation results are shown in Table 3 below.

### Examples 16 to 18

A moisture-absorbing material was obtained in the same manner as in Example 1 except that the amorphous silica in Example 1 was changed to wet silica (MIZUKASIL P705, manufactured by MIZUSAWA INDUSTRIAL CHEMICALS, LTD.) and the kind and the amount of polyvinyl alcohol (PVA), which is a water-soluble resin, and the presence of the crosslinking agent were changed as shown in Table 3 below and further a molded article was prepared. The obtained moisture-absorbing material and molded article were evaluated as in the same manner as in Example 1. The evaluation results are shown in Table 3 below.

### Examples 19 to 23

A moisture-absorbing material was obtained in the same manner as in Example 1 except that the kind and the amount of polyvinyl alcohol (PVA) which is a water-soluble resin and the presence of the crosslinking agent in Example 1 were changed as shown in Table 3 below and further a molded article was prepared. The obtained moisture-absorbing material and molded article were evaluated in the same manner as in Example 1. The evaluation results are shown in Table 3 below.

### Example 24

A moisture-absorbing material was obtained in the same manner as in Example 1 except that calcium chloride which is a moisture-absorbing agent in Example 1 was changed to magnesium sulfate and further a molded article was prepared. The obtained moisture-absorbing material and molded article were evaluated in the same manner as in Example 1. The evaluation results are shown in Table 3 below.

TABLE 3

| | | Moisture-absorbing layer | | | | | | | | | | | | | | | | | |
|---|---|---|---|---|---|---|---|---|---|---|---|---|---|---|---|---|---|---|---|
| | Thick- | | | | | | | (Ratio | | | | | | Thickness of | | | | | |
| | ness | | | | | | | between | | | | | | adhesive | | | | | |
| | of | | | | | Saponi- | Polymer- | amorphous | | | | | Average | [between | Evaluation | | | | |
| | polymer | | Primary | Secondary | | fication | ization | silica and) | | Void | | Moisture- | pore | moisture-proof | | | Moisture | Moisture- | |
| | layer | Type of | particle | particle | | degree | degree of | Amount of | | vol- | Crosslinking | absorbing | diameter | layer and | Trans- | Visi- | absorption | absorbing | Crack- |
| | [μm] | silica | diameter | diameter | | of PVA | PVA | PVA | Thickness | ume | agent | agent | [μm] | porous layer] | parency | bility | capacity | rate | ing |
| Example | 20 | Vapor | 7 nm | 20 | nm | 88% | 4,500 | 40% | 36 μm | 62% | None | CaCl₂ | 20 | 3 | A | A | A | 3 Days | A |
| 11 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 88% | 3,300 | 40% | 36 μm | 62% | None | CaCl₂ | 20 | 3 | A | A | A | 3 Days | B |
| 12 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 88% | 4,500 | 55% | 36 μm | 58% | None | CaCl₂ | 20 | 3 | A | A | B | 3 Days | A |
| 13 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 88% | 4,500 | 30% | 36 μm | 64% | None | CaCl₂ | 23 | 3 | A | A | A | 3 Days | B |
| 14 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 88% | 4,500 | 40% | 34 μm | 63% | None | CaCl₂ | 20 | 3 | A | A | A | 3 Days | A |
| 15 | | phase | | | | | | | | | | | | | | | | | |
| | | process | | | | | | | | | | | | | | | | | |
| | | silica 1 | | | | | | | | | | | | | | | | | |
| Example | 20 | Wet silica | — | 3 | μm | 88% | 4,500 | 40% | 33 μm | 62% | None | CaCl₂ | 35 | 3 | C | C | A | 3 Days | A |
| 16 | | | | | | | | | | | | | | | | | | | |
| Example | 20 | Wet silica | — | 3 | μm | 88% | 3,300 | 40% | 33 μm | 62% | None | CaCl₂ | 35 | 3 | C | C | A | 3 Days | B |
| 17 | | | | | | | | | | | | | | | | | | | |
| Example | 20 | Wet silica | — | 3 | μm | 96% | 3,300 | 20% | 33 μm | 68% | Boric acid | CaCl₂ | 35 | 3 | C | C | A | 3 Days | B |
| 18 | | | | | | | | | | | | | | | | | | | |
| Example | 20 | Vapor | 7 nm | 20 | nm | 88% | 3,300 | 30% | 36 μm | 62% | Boric acid | CaCl₂ | 21 | 3 | A | A | B | 3 Days | A |
| 19 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 88% | 4,500 | 28% | 36 μm | 62% | None | CaCl₂ | 20 | 3 | A | C | A | 3 Days | C |
| 20 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 95% | 3,300 | 30% | 36 μm | 62% | None | CaCl₂ | 20 | 3 | C | C | A | 3 Days | C |
| 21 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 88% | 4,500 | 60% | 33 μm | 58% | None | CaCl₂ | 23 | 3 | A | A | C | 3 Days | A |
| 22 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 88% | 2,400 | 65% | 31 μm | 58% | None | CaCl₂ | 22 | 3 | C | C | B | 3 Days | C |
| 23 | | phase | | | | | | | | | | | | | | | | | |
| | | process | | | | | | | | | | | | | | | | | |
| | | silica 1 | | | | | | | | | | | | | | | | | |
| Example | 20 | Vapor | 7 nm | 20 | nm | 88% | 4,500 | 40% | 40 μm | 62% | None | MgSO₄ | 20 | 3 | A | A | C | 4 Days | A |
| 24 | | phase | | | | | | | | | | | | | | | | | |
| | | process | | | | | | | | | | | | | | | | | |
| | | silica 1 | | | | | | | | | | | | | | | | | |

As shown in Table 3, in each Example, a moisture-absorbing material having excellent transparency and visibility, high hygroscopicity, and a large moisture absorption capacity was obtained.

### INDUSTRIAL APPLICABILITY

According to the present invention, it is possible to provide a moisture-absorbing material having a large moisture absorption capacity and high transparency and capable of controlling the moisture-absorbing rate by a constituent material, a method for manufacturing the same, and a packaging material.

The present application claims priority from Japanese Patent Application No. 2013-100575 and Japanese Patent Application No. 2014-083198, the contents of which are herein incorporated by reference in their entirety.

All the documents, patent applications and technical standards described in the specification are incorporated into the specification for reference to the same extent as cases in which it is specifically and respectively described that the respective documents, patent applications and technical standards are incorporated for reference.

What is claimed is:

1. A moisture-absorbing material comprising, in the following order:
a moisture-permeable polymer layer;
a moisture-absorbing layer having a porous structure and comprising amorphous silica having an average secondary particle diameter of 10 μm or less, a water-soluble resin and a moisture-absorbing agent; and
a moisture-proof layer.

2. The moisture-absorbing material according to claim 1,
wherein the moisture-absorbing layer has a thickness of 20 μm to 50 μm, and
the moisture-absorbing layer has a void volume of 45% to 85%.

3. The moisture-absorbing material according to claim 1,
wherein the amorphous silica comprises at least one of vapor phase process silica and wet silica.

4. The moisture-absorbing material according to claim 1,
wherein the moisture-absorbing layer has an average pore diameter of 40 nm or less.

5. The moisture-absorbing material according to claim 3,
wherein the vapor phase process silica has an average primary particle diameter of 10 nm or less.

6. The moisture-absorbing material according to claim 5,
wherein the vapor phase process silica has an average secondary particle diameter of 25 nm or less.

7. The moisture-absorbing material according to claim 1,
wherein the water-soluble resin comprises a polyvinyl alcohol having a saponification degree of 99% or less and a polymerization degree of 3,300 or higher.

8. The moisture-absorbing material according to claim 1,
wherein the moisture-absorbing layer further comprises boric acid as a crosslinking agent.

9. The moisture-absorbing material according to claim 1,
wherein the moisture-absorbing agent comprises calcium chloride.

10. The moisture-absorbing material according to claim 1,
wherein the polymer layer has a thickness of 20 nm to 100 nm.

11. The moisture-absorbing material according to claim 1, further comprising:
an adhesive layer between the moisture-proof layer and the moisture-absorbing layer.

12. The moisture-absorbing material according to claim 11,
wherein the adhesive layer comprises a polyurethane resin adhesive, and the adhesive layer has a thickness of 3 μm to 15 μm.

13. A packaging material comprising:
the moisture-absorbing material according to claim 1.

14. A packaging material comprising:
one or a plurality of the moisture-absorbing material according to claim 1,
wherein the packaging material has an adhesion site in which a part of a polymer layer of one moisture-absorbing material is bonded with another part of the moisture-absorbing material, or an adhesion site in which a part of a polymer layer of a first moisture-absorbing material is bonded with a part of a second moisture-absorbing material.

15. A method for manufacturing a moisture-absorbing material, comprising:
forming a moisture-absorbing layer by forming a layer having a porous structure by applying a coating liquid comprising amorphous silica having an average secondary particle diameter of 10 μm or less and a water-soluble resin to any one of a moisture-permeable polymer layer and a moisture-proof layer and applying a solution comprising a moisture-absorbing agent to the porous structure to impregnate the porous structure with the moisture-absorbing agent; and
laminating the other one of the polymer layer and the moisture-proof layer on the moisture-absorbing layer impregnated with the moisture-absorbing agent.

16. The method for manufacturing a moisture-absorbing material according to claim 15,
wherein the moisture-absorbing agent comprises calcium chloride.
